(19) United States
(12) Patent Application Publication
(10) Pub. No.: US 2024/0154753 A1
(43) Pub. Date: May 9, 2024

(54) UPLINK TRANSMISSION TECHNIQUES

(71) Applicant: ZTE Corporation, Shenzhen (CN)

(72) Inventors: Ke YAO, Shenzhen (CN); Bo GAO, Shenzhen (CN); Xiaolong GUO, Shenzhen (CN); Shujuan ZHANG, Shenzhen (CN); Yang ZHANG, Shenzhen (CN); Minqiang ZOU, Shenzhen (CN); Zhaohua LU, Shenzhen (CN)

(21) Appl. No.: 18/533,514

(22) Filed: Dec. 20, 2023

Related U.S. Application Data
(63) Continuation of application No. PCT/CN2022/106834, filed on Jul. 20, 2022.

(51) Int. Cl. H04L 5/00; H04B 7/0456

(52) U.S. Cl. CPC H04L 5/0048; H04B 7/0456

(57) ABSTRACT

Techniques are described for performing physical uplink shared channel (PUSCH) transmission. An example wireless communication method includes performing, by a communication device, an uplink transmission, where the uplink transmission is performed using a precoder, where the precoder is based on one or more sounding reference signal (SRS) resources, one or more ranks, and/or one or more precoding matrix indicators, and where one precoding matrix indicator of the one or more precoding matrix indicators indicates a precoding matrix for a rank.

### CROSS REFERENCE TO RELATED APPLICATIONS

This patent document is a continuation of and claims benefit of priority to International Patent Application No. PCT/CN2022/106834, filed on Jul. 20, 2022. The entire content of the before-mentioned patent application is incorporated by reference as part of the disclosure of this application.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for performing physical uplink shared channel (PUSCH) transmission.

An example wireless communication method includes performing, by a communication device, an uplink transmission, where the uplink transmission is performed using a precoder, where the precoder is based on one or more sounding reference signal (SRS) resources, one or more ranks, and/or one or more precoding matrix indicators, and where one precoding matrix indicator of the one or more precoding matrix indicators indicates a precoding matrix for a rank.

In some embodiments, the one precoding matrix indicator of the one or more precoding matrix indicators comprises: a transmitted precoding matrix indicator (TPMI) or an index that indicates the precoding matrix for the rank based on a predefined precoding matrix table, or a set of parameters to determine the precoding matrix for the rank. In some embodiments, at least two SRS resources from the one or more SRS resources are configured with a sum of eight antenna ports, or one SRS resource of the one or more SRS resources is configured with eight antenna ports. In some embodiments, at least one SRS resource is indicated by one SRS resource indicator (SRI), each of the at least one SRS resource is indicated by a respective SRI in one SRS resource set, or each of the at least one SRS resource is indicated by a respective SRI corresponding to a respective SRS resource set. In some embodiments, the method further comprises receiving, by the communication device from a network device, a first indication having a value that indicates the one or more ranks and/or the one or more precoding matrix indicators.

In some embodiments, the value of the first indication indicates the one or more ranks and/or the one or more precoding matrix indicators based on a predetermined table, the predetermined table comprises a plurality of entries, each entry of the plurality of entries corresponds to a respective value of the first indication, and each entry of the plurality of entries corresponds to at least one rank and/or at least one precoding matrix indicator. In some embodiments, the plurality of entries comprise any one or more of: one or more entries of type one, one or more entries of type two, one or more entries of type three, or one or more entries of type four, where each of the type one, the type two, the type three, and the type four is associated with at least one rank and/or at least one precoding matrix indicator. In some embodiments, more than one entry with different types correspond to any one or more of: different number of ranks, different value range of ranks, different number of precoding matrix indicators, or different size of precoding matrices corresponding to precoding matrix indicators. In some embodiments, an entry of type one indicates one rank and/or one precoding matrix indicator, an entry of type two indicates two ranks and/or one precoding matrix indicator or two precoding matrix indicators, an entry of type three indicates four ranks and/or one precoding matrix indicator or four precoding matrix indicators, or an entry of type four indicates eight ranks.

In some embodiments, a bit size of the first indication is according to any one or more of: a predefined value, a parameter configured by the network device, or a number of entries in the predetermined table. In some embodiments, the method further comprises receiving, by the communication device from a network device, a type indication, and one or more second indications, one of the one or more second indications indicates one rank, and a number of the one or more second indications or a bit size of a second indication is according to or based on a relationship with the type indication. In some embodiments, the one of the one or more second indications indicates one rank and one precoding matrix indicator. In some embodiments, the one of the one or more second indications indicates one rank without a precoding matrix indicator. In some embodiments, the type indication indicates one of: a type one which indicates one group, a type two which indicates two groups, a type three which indicates four groups, or a type four which indicates eight groups or a special group.

In some embodiments, each group corresponds to a respective second indication, or the special group corresponds to a second indication which indicates a combination of ranks. In some embodiments, the method further comprises receiving, by the communication device from a network device, a rank indication, and zero or one or more third indications, where the rank indication indicates one or more ranks, and where one of the one or more third indications indicates one precoding matrix indicator corresponding to a rank indicated by the rank indication. In some embodiments, a number of the one or more third indications or a bit size of a third indication is according to or based on a relationship with the rank indication. In some embodiments, the method further comprises transmitting, from the communication device to the network device, any one or more of the following capabilities: a coherent capability, a common or separate precoding matrix indicator among port groups, a layer alignment among port groups, or a maximum number of layers for a port group; or receiving, by the communication device from the network device, any one or more of the following capabilities: a coherent capability, a common or separate precoding matrix indicator among port groups, a layer alignment among port groups, or a maximum number of layers for a port group.

In some embodiments, the coherent capability comprises any one or more of: capability 1 with full coherent, first partial type coherent, second partial type coherent, and non-coherent capabilities, capability 2 with first partial type coherent, second partial type coherent, and non-coherent capabilities, capability 3 with second partial type coherent, and non-coherent capabilities, or capability 4 with non-coherent capability. In some embodiments, the method further comprises receiving, by the communication device from a network device, a mode parameter, where the communication device determines a value or a candidate value set of a precoding matrix parameter for one or more ranks according to the mode parameter. In some embodiments, a value of the mode parameter is associated with the value or the candidate value set of the precoding matrix parameter for the one or more ranks. In some embodiments, the communication device determines a value of an oversampling factor for one or more ranks according to the mode parameter, the communication device determines a value set of a precoding matrix parameter of phase offset according to the mode parameter, or the communication device determines a value set of a precoding matrix parameter of layer offset according to the mode parameter.

In some embodiments, the mode parameter is received in a downlink control information (DCI) signaling, a medium access control-control element (MAC CE) signaling, or a radio resource control (RRC) signaling. In some embodiments, a default value of a precoding matrix parameter is determined in a predetermined manner, or is determined according to a parameter configured or indicated by the network device for a rank, and a particular value determined for the precoding matrix parameter for one or more particular ranks according to the mode parameter updates the default value for the one or more particular ranks. In some embodiments, a particular value determined for a precoding matrix parameter for one or more particular ranks is according to the mode parameter, and a default value of the precoding matrix parameter is determined in a predetermined manner, or is determined according to a parameter configured or indicated by the network device for a rank other than the one or more particular ranks. In some embodiments, the communication device determines a value or a candidate value set of a precoding matrix parameter for one or more ranks to be different from that for another rank. In some embodiments, the precoding matrix parameter comprises any one or more of an oversampling factor, a number of horizontal antenna elements on one polarization, or a number of vertical antenna elements on one polarization.

Another example wireless communication method includes receiving, by a network device, an uplink transmission, where the uplink transmission is based on a precoder, where the precoder is based on one or more sounding reference signal (SRS) resources, one or more ranks, and/or one or more precoding matrix indicators transmitted to the communication device, and where one precoding matrix indicator of the one or more precoding matrix indicators indicates a precoding matrix for a rank.

In some embodiments, the one precoding matrix indicator of the one or more precoding matrix indicators comprises: a transmitted precoding matrix indicator (TPMI) or an index that indicates the precoding matrix for the rank based on a predefined precoding matrix table, or a set of parameters to determine the precoding matrix for the rank. In some embodiments, at least two SRS resources from the one or more SRS resources are configured with a sum of eight antenna ports, or one SRS resource of the one or more SRS resources is configured with eight antenna ports. In some embodiments, at least one SRS resource is indicated by one SRS resource indicator (SRI), each of the at least one SRS resource is indicated by a respective SRI in one SRS resource set, or each of the at least one SRS resource is indicated by a respective SRI corresponding to a respective SRS resource set. In some embodiments, the method further comprises transmitting, by the network device to the communication device, a first indication having a value that indicates the one or more ranks and/or the one or more precoding matrix indicators.

In some embodiments, the value of the first indication indicates the one or more ranks and/or the one or more precoding matrix indicators based on a predetermined table, and the predetermined table comprises a plurality of entries, each entry of the plurality of entries corresponds to a respective value of the first indication, and each entry of the plurality of entries corresponds to at least one rank and/or at least one precoding matrix indicator. In some embodiments, the plurality of entries comprise any one or more of: one or more entries of type one, one or more entries of type two, one or more entries of type three, or one or more entries of type four, where each of the type one, the type two, the type three, and the type four is associated with at least one rank and/or at least one precoding matrix indicator. In some embodiments, more than one entry with different types correspond to any one or more of: different number of ranks, different value range of ranks, different number of precoding matrix indicators, or different size of precoding matrices corresponding to precoding matrix indicators. In some embodiments, an entry of type one indicates one rank and/or one precoding matrix indicator, an entry of type two indicates two ranks and/or one precoding matrix indicator or two precoding matrix indicators, an entry of type three indicates four ranks and/or one precoding matrix indicator or four precoding matrix indicators, or an entry of type four indicates eight ranks. In some embodiments, a bit size of the first indication is determined according to any one or more of: a predefined value, a parameter configured by the network device, or a number of entries in the predetermined table.

In some embodiments, the method further comprises transmitting, by the network device to the communication device, a type indication, and one or more second indications, where one of the one or more second indications indicates one rank, and where a number of the one or more second indications or a bit size of a second indication is determined according to or based on a relationship with the type indication. In some embodiments, the one of the one or more second indications indicates one rank and one precoding matrix indicator. In some embodiments, the one of the one or more second indications indicates one rank without a precoding matrix indicator. In some embodiments, the type indication indicates one of: a type one which indicates one group, a type two which indicates two groups, a type three which indicates four groups, or a type four which indicates eight groups or a special group. In some embodiments, each group corresponds to a respective second indication, or the special group corresponds to a second indication which indicates a combination of ranks.

In some embodiments, the method further comprises transmitting, by the network device to the communication device, a rank indication, and one or more third indications, where the rank indication indicates one or more ranks, and where one of the one or more third indications indicates one precoding matrix indicator corresponding to a rank indicated by the rank indication. In some embodiments, a number of the one or more third indications or a bit size of a third indication is determined according to or based on a relationship with the rank indication. In some embodiments, the method further comprises receiving, by the network device from the communication device, any one or more of the following capabilities: a coherent capability, a common or separate precoding matrix indicator among port group, a layer alignment among port groups, or a maximum number of layers for a port group; or transmitting, by the network device to the communication device, any one or more of the following capabilities: a coherent capability, a common or separate precoding matrix indicator among port group, a layer alignment among port groups, or a maximum number of layers for a port group.

In some embodiments, the coherent capability comprises any one or more of: capability 1 with full coherent, first partial type coherent, second partial type coherent, and non-coherent capabilities, capability 2 with first partial type coherent, second partial type coherent, and non-coherent capabilities, capability 3 with second partial type coherent, and non-coherent capabilities, or capability 4 with non-coherent capability. In some embodiments, the method further comprises transmitting, by the network device to the communication device, a mode parameter, where a value or a candidate value set of a precoding matrix parameter for one or more ranks is based on the mode parameter. In some embodiments, a value of the mode parameter is associated with the value or the candidate value set of the precoding matrix parameter for the one or more ranks. In some embodiments, the mode parameter is transmitted in a downlink control information (DCI) signaling, a medium access control-control element (MAC CE) signaling, or a radio resource control (RRC) signaling.

In some embodiments, a default value of a precoding matrix parameter is determined in a predetermined manner, or is determined according to a parameter configured or indicated by the network device for a rank, and a particular value determined for the precoding matrix parameter for one or more particular ranks according to the mode parameter updates the default value for the one or more particular ranks. In some embodiments, a particular value determined for a precoding matrix parameter for one or more particular ranks is according to the mode parameter, and a default value of the precoding matrix parameter is determined in a predetermined manner, or is determined according to a parameter configured or indicated by the network device for a rank other than the one or more particular ranks.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a two transmission (Tx) antenna port architecture.

FIG. 2 shows a 4Tx antenna port architecture.

FIG. 3 shows a 8Tx antenna port architecture.

FIG. 4A shows an exemplary flowchart for performing an uplink transmission.

FIG. 4B shows an exemplary flowchart for receiving an uplink transmission.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

### DETAILED DESCRIPTION

In current wireless communication system, transmission data rate for uplink (UL) can be a bottleneck compared to that for downlink (DL). Thus, techniques are developed for enhancing for uplink performance. One technique to improve data rate for uplink is by increasing number of antennas on UE, e.g., from 4 transmission (Tx) antenna ports to 8Tx antenna ports. However, due to cost and complexity issue, 8Tx antenna ports may not be coherent and may not be supported for UL transmission. Thus, this patent document describes techniques that can be used to, among other things, design codebook for 8Tx antenna ports, which can be used for partial coherent and non-coherent user equipment (UE).

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology or 5G Advance technology only, and may be used in wireless systems that implemented other protocols.

### I. Introduction

Physical uplink shared channel (PUSCH) transmission from a UE is scheduled based on sounding reference signal (SRS) transmission from a base station to the UE. SRS resource(s) are configured in SRS resource set by using codebook or non-codebook transmitted to UE by network (or base station or gNB) via RRC signaling used for codebook based PUSCH transmission or non-codebook based PUSCH transmission, respectively. As mentioned above, 8 Tx antenna ports are currently not supported for UL transmission. Thus, schemes for precoding matrix (also known as codebook), rank and transmitted precoding matrix indicator (TPMI) indication need to be designed for at least 8Tx antenna ports. While this patent application describes technical solutions for 8Tx antenna ports, the disclosed technical solutions can be employed for a plurality of Tx antenna ports (e.g., 2Tx antenna ports or 4Tx antenna ports, etc.,).

### II. UE Antenna Architecture

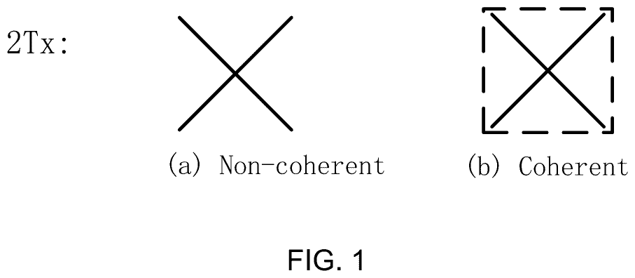

Similar to DL codebook architecture, for UE Tx antenna architecture, coherent Tx antenna ports are usually arranged as cross polarized. 2Tx, 4Tx, 8Tx UE. Tx antenna architectures with non-coherent, partial coherent and full coherent capability are shown in FIGS. 1-3. The dashed boxes in FIGS. 1-3 means that the marked Tx(s) are coherent.

FIG. 1 shows a 2Tx antenna port architecture, for which non-coherent and coherent types may be needed.

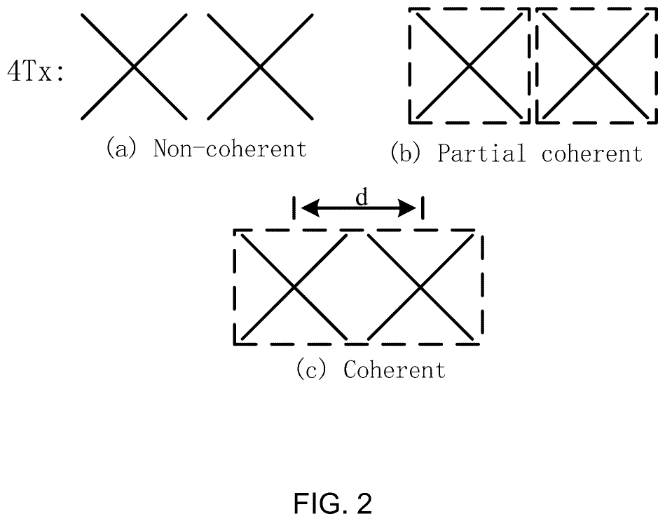

FIG. 2 shows a 4Tx antenna port architecture, for which the following properties may be needed:
Non-coherent, partial and coherent types are needed.
For full coherent, distance between two groups of cross polarization can be λ/2 or any other values (e.g., K*λ in general, or other value for distributed antennas, such as Heterogeneous or UE aggregation), where λ is wavelength.
Tx beam should be polarization-common.
A single phase value applies to precoder(s) of all antennas with same polarization (e.g., per layer).

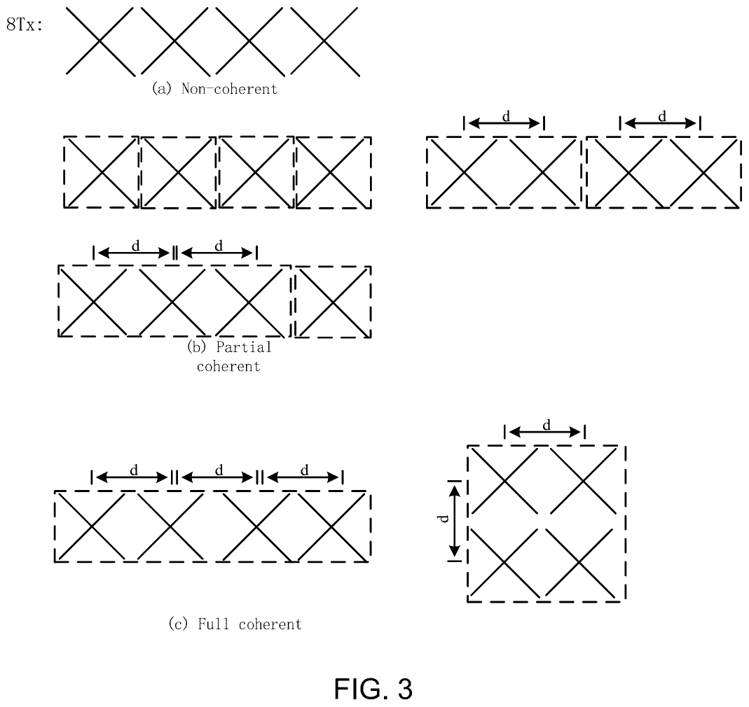

FIG. 3 shows a 8Tx antenna port architecture, for which the following properties may be needed:

Combinations of {2, 2, 2, 2}, {4, 4}, {6, 2} can be considered for partial coherent case.

### III. Embodiment 0: Factors for Determining a Precoding Matrix

A precoder (or precoding matrix, precoding information) is determined according to at least one of following factor:
Number of ports, (N1*N2*P),
   a. N1, N2 are numbers of rows and columns of antenna elements in a panel (antenna panel) respectively. Or N1 is defined as a number of horizontal antenna elements on one polarization. N2 is defined as a number of vertical antenna elements on one polarization. N1, N2 can be N₁, N₂ respectively.
   b. P is 2 for polarized ports, in this case there are 2 groups of ports which can be horizontal polarized group, and vertical polarized group, or can be +45 and −45 degree crossing polarized groups
   c. Number of ports is determined as N1*N2*P
Oversampling factor, (O1, O2)
   a. O1 is defined as a value of an oversampling factor on one polarization in a horizontal direction. O2 is defined as a value of oversampling factor on one polarization in a vertical direction. O1, O2 can be O₁, O₂ respectively.
Number of layers (or value of rank, can be simplified as rank),
At least one Vector, each for a layer, e.g., DFT vector,
Phase offset (phi) between polarized ports, where the phase offset is also referred to as i2 (or i₂) in this patent document,
Offset of layer (or layer offset, for determining which vector is used by a layer), where the offset of layer is also referred to as i13 or i1,3 (or i_{1,3}) in this patent document, or
Coherent level (indicating coherent relation between transmit ports)
   a. Comprises any one or more of: full coherent, partial coherent, non-coherent
   b. Full coherent ports can be compatible with partial coherent, non-coherent features, e.g., precoding matrix.
   c. Partial coherent ports can be compatible with non-coherent
   d. Full coherent may be noted as full-and-partial-and-non-coherent
   e. Partial coherent may be noted as partial-and-non-coherent

For example, assuming number of ports is X1, number of layers is X2,

a precoding matrix has number of rows X1, and number of columns X2, which means each row corresponds to a port, and each column corresponds to a layer.

X1=N1*N2*P .

A vector has X1 elements for each layer.

If P=2, a phase offset exists between polarized ports.

If more than one port are coherent, they can be used for transmitting for a same layer, since the phase offset between the more than one port can be well controlled. Or the more than one port are not coherent, they cannot be used for transmitting for a same layer, since phase offset between the more than one port cannot be ensured.

There are 2 schemes to determine a precoding matrix considering the above factors.

### Scheme 1: via Separate Factor Indication

Each one or more of the above factors can be indicated by a field or an indication. All the indicated factors are used to determine a precoding matrix.

### Scheme 2: via a Precoding Matrix Index

A list of precoding matrices can be provided, each precoding matrix reflect a combination of all or part of the above factors. And a precoding matrix index, e.g., PMI, or TPMI, is provided to determine a precoding matrix.

For example, assuming N1*N2*P=8 for 8TX 8 port precoding matrix design, e.g. N1=4, O1=4, N2=1, N2=1, P=2, precoding matrix W is determined according to i11, i12, i2, or i13 which is same as for DL 8TX. O1 is an over-sampling factor for N1, and O2 is an over-sampling factor for N2. Here 1 layer, 2 layers and 5 layers are shown as following. For R=1, i.e., 1 layer, precoding matrix W is determined according to:

| i_{1,1} | i_{1,2} | i₂ | |
|---|---|---|---|
| 0, 1, . . . , N₁O₁ − 1 | 0, . . . , N₂O₂ − 1 | 0, 1, 2, 3 | Wᵢ_{_{1,1}}_{,i}_{_{1,2}}_{,i}_{₂}⁽¹⁾ |

$where {W}_{l , m , n}^{〈 1 )} = \frac{1}{\sqrt{{P}_{CSI - RS}}} [ \begin{matrix}{v}_{l , m} \\ {φ}_{n} {v}_{l , m}\end{matrix} ] .$

For R=2, i.e., 2 layers, precoding matrix W is determined according to:

| i_{1,1} | i_{1,2} | i₂ | |
|---|---|---|---|
| 0, 1, . . . , N₁O₁ − 1 | 0, . . . , N₂O₂ − 1 | 0,1 | Wᵢ_{_{1,1}}_{,i}_{_{1,1}}₊ₖ_{₁}_{,i}_{_{1,2}}_{,i}_{_{1,2}}₊ₖ_{₂}_{,i}_{₂}⁽²⁾ |

$where {W}_{l , {l}^{′} , m , {m}^{′} , n}^{( 2 )} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ] .$
and the mapping from i_{1,3} to k₁ and k₂ is given in Table 5.2.2.2.1-3 of TS 38.214.

The mapping from i_{1,3} to k₁ and k₂ for 2-layer reporting is given in Table 5.2.2.2.1-3.

TABLE 5.2.2.2.1-3
Mapping of i_{1, 3} to k₁ and k₂ for 2-layer CSI reporting

| | N₁ > N₂ > 1 | | N₁ = N₂ | | N₁ = 2, N₂ = 1 | | N₁ > 2, N₂ = 1 | |
|---|---|---|---|---|---|---|---|---|
| i_{1, 3} | k₁ | k₂ | k₁ | k₂ | k₁ | k₂ | k₁ | k₂ |
| 0 | 0 | 0 | 0 | 0 | 0 | 0 | 0 | 0 |
| 1 | O₁ | 0 | O₁ | 0 | O₁ | 0 | O₁ | 0 |
| 2 | 0 | O₂ | 0 | O₂ | | | 2O₁ | 0 |
| 3 | 2O₁ | 0 | O₁ | O₂ | | | 3O₁ | 0 |

For R=5, i.e., 5 layers, precoding matrix W is determined according to:

| | i_{1,1} | i_{1,2} | i₂ | |
|---|---|---|---|---|
| N₂ >1 | 0, . . . , N₁O₁ − 1 | 0, . . . , N₂O₂ − 1 | 0,1 | Wᵢ_{_{1,1}}_{,i}_{_{1,1}}_{+O}_{₁}_{,i}_{_{1,1}}_{+O}_{₁}_{,i}_{_{1,2}}_{,i}_{_{1,2}}_{,i}_{_{1,2}}_{+O}_{₂}_{,i}_{₂}⁽⁵⁾ |
| N₁ > 2, N₂ = 1 | 0, . . . , N₁O₁ − 1 | 0 | 0,1 | Wᵢ_{_{1,1}}_{,i}_{_{1,1}}_{+O}_{₁}_{,i}_{_{1,1}}_{+2O}_{₁},_{0,0,0,i}_{₂}⁽⁵⁾ |
| $where {W}_{l , {l}^{′} , {l}^{″} m , {m}^{′} {m}^{″} , n}^{( 5 )} = \frac{1}{\sqrt{5 {P}_{CSI - RS}}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} \\ {φ}_{n} {v}_{l , m} & - {φ}_{n} {v}_{l , m} & {v}_{{l}^{′} , {m}^{′}} & - {v}_{{l}^{′} , {m}^{′}} & {v}_{{l}^{″} , {m}^{″}}\end{matrix} ] .$ | | | | |

The quantities φₙ, θₚ, uₘ, ν_{l,m}, and \tilde{ν}_{l,m} are given by

$${φ}_{n} = {e}^{j π n / 2}$$

$${θ}_{p} = {e}^{j π p / 4}$$

$${u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix}$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} & {u}_{m}\end{matrix} ]}^{T}$$

$${\tilde{v}}_{l , m} = {[ \begin{matrix}{u}_{m} & {e}^{j \frac{4 π l}{{O}_{1} {N}_{1}}} {u}_{m} & … & {e}^{j \frac{4 π l ( {N}_{1} / 2 - 1 )}{{O}_{1} {N}_{1}}} & {u}_{m}\end{matrix} ]}^{T}$$

For an 8TX precoding matrix based on 4 port vector via determined precoding matrix, a phase offset ϕₙ may be needed.
E.g., for full coherent 8TX precoding matrix with P=2, a 4-D vector and a phase offset can be used determine 2 8-D vectors.
the first vector of 8-D can be determined by two 4-D vectors, and the second 4-D vector is determined by multiplying the first 4-D vectors by the second phase offset. Assuming v is a 4*1 matrix, 2 8-D vectors can be determined as:

$$[ \begin{matrix}v & v \\ {ϕ}_{n} v & - {ϕ}_{n} v\end{matrix} ]$$

v can also be replaced by a 4-D matrix, which has L columns (for L layers), L is larger than 1 and less or equal to 4. then at most 2L 8-D vectors can be determined as above.

### IV. Embodiment 1: TPMI and Rank Indication

A UE receives a command, e.g., DCI, from a gNB or a network (NW), scheduling a PUSCH transmission with a reference of one or more SRS resources. The one or more SRS resources can be determined by the gNB based on one or more SRIs corresponding to one or more SRS resource sets. The one or more SRS resources can also be determined as the single SRS resource or all the SRS resources in an SRS resource set, then no SRI is needed. The one or more SRS resources can be simplified as the determined SRS resource(s) or the reference SRS resource(s), for the PUSCH transmission.

The reference SRS resource can be configured with 8 ports. Or the more than one reference SRS resources is configured with a sum of 8 ports. For example,
SRS case 1: one SRS resource configured with 8 ports, is indicated by one SRI in one SRS resource set. This can be applicable for the case of fully coherent 8 ports, or 2 sets of 4 coherent ports, or 4 sets of 2 coherent port, or 8 non-coherent ports. The ports between different sets of the 2 sets or the 4 sets are not coherent, or coherent.
SRS case 2: more than one SRS resource configured with a sum of 8 ports, are indicated by one SRI in one SRS resource set. For example, 2 SRS resources, each of which is configured with 4 ports, or 4 SRS resources, each of which is configures with 2 ports. Each SRS resource corresponds to a port group, TPMI/vector. The ports between different sets of the 2 sets or the 4 sets are not coherent, or coherent.
1 SRI can indicate more than one SRS resource, how to determine such case is used?
SRS case 3: more than one SRS resource configured with a sum of 8 ports, are indicated by more than one SRI in one SRS resource set. One SRI indicates one SRS resource. For example, 2 SRS resources, each of which is configured with 4 ports, or 4 SRS resources, each of which is configures with 2 ports. Each SRS resource corresponds to a port group, TPMI/vector. The ports between different sets of the 2 sets or the 4 sets are not coherent, or coherent.
SRS case 4: more than one SRS resource configured with a sum of 8 ports, are indicated by more than one SRI in more one SRS resource set. One SRI corresponding to one SRS resource set indicates one or more SRS resources. For example, 2 SRS resources, each of which is configured with 4 ports, or 4 SRS resources, each of which is configures with 2 ports. Each SRS resource corresponds to a port group, TPMI/vector. The ports between different sets of the 2 sets or the 4 sets are not coherent, or coherent.
SRS case 5: all of one or more SRS resources configured with a sum of 8 ports, within one SRS resource set are applied to the PUSCH transmission. For example, there may be only one spatial relation for all of SRS resources within a SRS resource set in FR1. In other words, it may not need to identify spatial relation for SRS resource in FR1. So no SRI is needed to indicate one or more SRS resources in a SRS resource set, all of the SRS resources within a SRS resource set is indicated by default if a SRS resource set is identified. The SRS resource set can be indicated by a DCI, or is the only one SRS resource set with usage of codebook. For example, 2 SRS resources, each of which is configured with 4 ports, or 4 SRS resources, each of which is configures with 2 ports. Each SRS resource corresponds to a port group, TPMI/vector. The ports between different sets of the 2 sets or the 4 sets are not coherent, or coherent.

The UE determines a precoder (or precoding information) for the PUSCH transmission according to one or more SRS resources, one or more ranks, and/or one or more TPMIs.

The one or more ranks, and/or one or more TPMIs can be indicated in a DCI or a MAC CE or a RRC signaling by a base station to the UE. An indication related to TPMI can be an index to indicate a vector or a matrix for precoding for a certain rank, or the UE can receive an indicator associated with a set of parameters to determine a vector or a matrix for precoding for a certain rank. The set of parameters may comprise at least one of i11 (related to N1 and/or O1, can also be i₁₁, or i_{1,1}), i12 (related to N2 and/or O2, can also be i₁₂, or i_{1,2}), i2 (phase offset, can also be i₂), or i13 (offset for layers, can also be i₁₃, or i_{1,3}). A precoding matrix indicator can indicate a precoding matrix for a rank. A precoding matrix can also be a precoding vector.

For a 8Tx (port, or antenna port) transmission, the one or more TPMIs can be
TPMI case A: One TPMI, e.g., for full coherent 8 ports, or one 8-port group
TPMI case B: a shared one TPMI for more than one group, e.g., 4-port group, or 2-port group.
TPMI case C: multiple TPMIs for multiple port groups, e.g., for partial/non-coherent cases

For one SRS resource configured with 8 ports, or more than one SRS resource configured with a sum of 8 ports, multiple TPMIs correspond to same number of multiple port groups respectively.

Determine number of port groups, the number of ports of TPMI:

In general, the number of port groups can be determined according to coherency capability of UE. Such as, one 8-port group for full coherent capability, two 4-port groups for partial-1 coherent capability, four 2-port groups for partial-2 coherent capability, and/or eight 1-port (groups).

Further, the number of groups, e.g., G, can be determined according to the number of rank values. The number of ports for TPMI depends on a rank indication, such as the number of rank values. The number of ports for TPMI can be determined as 8/G. where G is an integer equal to or larger than 1. For example, 2 rank values are indicated, G=2, the number of ports for TPMI is 8/2=4.

### V. Embodiment 2: DCI Field. Indication Type A: One Table

A UE receives an indication field from NW.

The indication field in a DCI or a MAC CE, or an RRC signaling, indicates one or more ranks, and/or one or more TPMIs. In other words, a value of the indication field indicates one or more ranks, and/or one or more TPMIs. The mapping between each value of the indication field and the one or more ranks, and/or the one or more TPMIs can be determined by a predefined table or list. Each entry of the table corresponds to one or more ranks and/ one or more TPMIs.

A rank can be a rank value, or a number of layers.

The type of entry in the table comprises at least one of first type, second type, third type, or fourth type.

An entry of a first type indicates one rank and one TPMI. The rank e.g., R1, can be a value of an integer of 1 to 8. The TPMI can indicate a first type of matrix, by at least one parameter. The first type of matrix has a size of 8*R1.

An entry of a second type indicates two ranks and two TPMIs. The rank e.g., R2_1, R2_2, can be a value of an integer of 0 to 4. The two ranks cannot be both 0s in an entry. A TPMI and a corresponding rank can indicate a second type of matrix. The two second type of matrices have sizes of 4*R2_1, and 4*R2_2.

Alternatively, an entry of a second type indicates two ranks and one TPMI. The rank e.g., R2_1, R2_2, can be a value of an integer of 0 to 4. The two ranks cannot be both 0s in an entry. The one TPMI can be used to determine two matrices with sizes of 4*R2_1, and 4*R2_2.

An entry of a third type indicates four ranks and four TPMIs. The rank e.g., R3_1, R3_2, R3_3, R3_4, can be a value of an integer of 0 to 2. The four ranks cannot be all 0s in an entry. A TPMI and a corresponding rank can indicate a third type of matrix. The four third type of matrices have sizes of 2*R3_1, 2*R3_2, 2*R3_3 and 2*R3_4.

Alternatively, an entry of a third type indicates four ranks and one TPMI. The rank e.g., R3_1, R3_2, R3_3, R3_4, can be a value of an integer of 0 to 2. The four ranks cannot be all 0s in an entry. The one TPMI can be used to determine four matrices with sizes of 2*R3_1, 2*R3_2, 2*R3_3 and 2*R3_4.

Alternatively, an entry of a third type indicates four ranks and two TPMIs. The rank e.g., R3_1, R3_2, R3_3, R3_4, can be a value of an integer of 0 to 2. The four ranks cannot be all 0s in an entry. One TPMI can be used to determine part of third type of matrices, e.g., two matrices with sizes of 2*R3_1, 2*R3_2, and the other TPMI can be used to determine another part of third type of matrices, e.g., two matrices with sizes of 2*R3_3 and 2*R3_4.

An entry of a fourth type indicates 8 ranks. no TPMI is needed for such type of entry. The rank e.g., R4, can be a value of an integer of 0 to 1. The eight ranks cannot be all 0s in an entry.

In the case a TPMI corresponding to more than one rank, the TPMI is called shared TPMI, or common TPMI.

Determine a number of each type of entries according to the number of candidate codebook set for the type of matrix (e.g., a matrix for uplink communication or a matrix for downlink communication).

For example, a number of the first type of entries can be 480, 2048, or 152 for the 3 types of candidate codebook sets, as shown in column 2-4, in table x-1. for UL case, the first 64 entries are for rank=1 with different precoding matrices with size of 8*1. The next 32 entries are for rank=1 with different precoding matrices with size of 8*2. the following entries are for rank=3˜8, each rank corresponding to separate number of different precoding matrices with size of 8*R. R is the corresponding rank value.

TABLE x-1

| | DL 4*1*2 | DL 2*2*2 | |
|---|---|---|---|
| | (N1 = 4, O1 = 4 | (N1 = 2, O1 = 4 | |
| Number | N2 = 1, O2 = 1) | N2 = 2, O2 = 4) | UL |
| rank = 1 | 64 | 256 | 64 |
| rank = 2 | 128 | 512 | 32 |
| rank = 3 | 96 | 384 | 16 |
| rank = 4 | 96 | 384 | 16 |
| rank = 5 | 32 | 128 | 8 |
| rank = 6 | 32 | 128 | 8 |
| rank = 7 | 16 | 128 | 4 |
| rank = 8 | 16 | 128 | 4 |
| sum | 480 | 2048 | 152 |

For example, a number of the second type of entries can be N1*N2-1. N1 or N2, can be 96 if table x-2 is applied. The first 32 values of N1 indicates different precoding matrices for rank=1, the following values of N1 indicates different precoding matrices for rank=2˜4 accordingly. The combination of N1 and N2 can be arranged in predefined order, e.g., N1 changes firstly, N2 changes secondly. Then the first 96 entries are for 96 values of N1 and the first value of N2, the following 96 entries are for 96 values of N1 and the second value of N2. . . . the rest can be done in the same manner.

TABLE x-2
DL 4Tx codebook

| Number | full coherent |
|---|---|
| rank = 1 | 32 |
| rank = 2 | 32 |
| rank = 3 | 16 |
| rank = 4 | 16 |
| sum | 96 |

In another example, a number of the second type of entries can be N1*N2-1. If table x-3 is applied, N1 or N2, can be 30 if the candidate codebook set are only for full coherent, and can be 62 if the candidate codebook set are for full coherent, partial coherent and non-coherent. Take 62 as example, the first 28 values of N1 indicates different precoding matrices for rank=1, and among them, the first 16 values of N1 indicates different precoding matrices for rank=1 for full coherent case, and the following 8 values are for partial coherent, and the last 4 values of the first 26 values are for non-coherent case. The following values of N1 indicates different precoding matrices for rank=2˜4 accordingly. The combination of N1 and N2 can be arranged in predefined order, e.g., N1 changes firstly, N2 changes secondly. Then the first 62 entries are for 62 values of N1 and the first value of N2, the following 62 entries are for 62 values of N1 and the second value of N2. The rest can be done in the same manner.

In case of common TPMI for the second type of entries, a number of the second type of entries can be determined according to the number of rank combination, the number of candidate precoding codebook for the maximum rank among the ranks corresponding to the rank combination. For example, for a rank combination, the first rank is 1, the second rank is 3, a common TPMI is indicated for the maximum rank among 1 and 3 which is 3, so the number of entries for this rank combination is 16 is table x-2 is used.

TABLE x-3
UL 4Tx codebook

| Number | full coh | Partial coh | non coh | sum |
|---|---|---|---|---|
| rank = 1 | 16 | 8 | 4 | 28 |
| rank = 2 | 8 | 8 | 6 | 22 |
| rank = 3 | 4 | 2 | 1 | 7 |
| rank = 4 | 2 | 2 | 1 | 5 |
| sum | 30 | 20 | 12 | 62 |

A number of the third type of entries can be N1*N2*N3*N4-1. Table x-4 or table x-5 can be used to determine the value of N1, N2, N3, N4. If Table x-4 is used, the value of N1, N2, N3, N4 can be 6. If Table x-5 is used, the value of N1, N2, N3, N4 can be 6 for only full coherent case, and 9 for full coherent and non-coherent case.

TABLE x-4
DL 4Tx codebook

| Number | full |
|---|---|
| rank = 1 | 4 |
| rank = 2 | 2 |
| sum | 6 |

TABLE x-5
UL 4Tx codebook

| Number | full | non | sum |
|---|---|---|---|
| rank = 1 | 4 | 2 | 6 |
| rank = 2 | 2 | 1 | 3 |
| sum | 6 | 3 | 9 |

Here we only provide some examples for possible candidate codebook scheme, the above method can also be used with other type of candidate codebook scheme.

A number of the fourth type of entries can be 28-1=255. or the number of the fourth type of entries can be smaller than 255, which means not all rank combination are needed.

Determine the bit size of the indication field as ┌log 2(N)┐. N is sum of the numbers of each type of entries in the table.

Determine bit size of DCI field, according to UE capability report/config

There may be first type of entries with rank and TPMI for 8-port full coherent precoding matrix, second type of entries with ranks and TPMI(s) for 4-port full coherent precoding matrix, third type of entries with ranks and TPMI(s) for 2-port full coherent precoding matrix, and fourth type of entries with ranks for 1-port and no TPMI.

There may be first type of entries with rank and TPMI for 8-port full coherent precoding matrix, and second type of entries with ranks and TPMI(s) for 4-port full and partial and non-coherent precoding matrix, with or without third type of entries with ranks and TPMI(s) for 2-port full and non-coherent precoding matrix, with or without fourth type of entries with ranks for 1-port and no TPMI.

Further, if there are second type of entries with ranks and TPMI(s) for 4-port full and partial and non-coherent precoding matrix, with third type of entries with ranks and TPMI(s) for 2-port full and non-coherent precoding matrix, there is no need to contain fourth type of entries in the table.

Further, if there are second type of entries with ranks and TPMI(s) for 4-port full and partial and non-coherent precoding matrix, with third type of entries with ranks and TPMI(s) for 2-port full and non-coherent precoding matrix, there may be some redundant 8-port matrix between second type and third type, the number of second type of entries can be reduced to avoid redundant 8-port matrix.

For example, for second type of entries, i.e., 2 4Tx groups, each group corresponding to a matrix of full, partial, and non with rank 0-4. To avoid redundancy, the combination can only keep one group with full coherent, and the other group with full and partial and non cohe, no need for redundant combination: partial+partial/non, non+non. For third type of entries, i.e., 4 2Tx groups, each group corresponding to a matrix of full/non with rank 0-2. To avoid redundancy, the combination can only keep full+full/non, no need redundant combination: non+non.

In the table, order of types is predefined, and can be: first type, second type, third type, and fourth type as described as above, or can be fourth type, third type, second type, or first type.

The order of entries within each type entries is predefined, and can be precoders change firstly for one port groups, then another port group. And for DL: index order: i11 increasing firstly, then i12, i2, i13, or other orders; for UL: TPMI increasing firstly, then phi if present, or other orders.

The UE may determine a max rank less than the value as above, i.e., 8 for first type, 4 for second type, 2 for third type. The max rank can be determined based on UE capability, or NW configuration, per port group for a type. E.g., max rank=4 for port group for first type, 2 for a port group for second type, 2 for a port group for third type.

TABLE A
One Table

| | | | Index | |
|---|---|---|---|---|
| 1 group | rank (1~8) | TPMI | 0~x-1 | rank + TPMI |
| 2 groups-1 | rank (0~4) | TPMI | x~y-1 | rank 1/2 + TPMI1/2 |
| 2 groups-2 | rank (0~4) | TPMI | | |
| 4 groups-1 | rank (0~2) | TPMI | y~z-1 | rank 1~4 + TPMI1~4 |
| 4 groups-2 | rank (0~2) | TPMI | | |
| 4 groups-3 | rank (0~2) | TPMI | | |
| 4 groups-4 | rank (0~2) | TPMI | | |
| 8 groups-1 | rank (0~1) | | z~za-1 | rank 1~8 |
| 8 groups-2 | rank (0~1) | | | |
| 8 groups-3 | rank (0~1) | | | |
| 8 groups-4 | rank (0~1) | | | |
| 8 groups-5 | rank (0~1) | | | |
| 8 groups-6 | rank (0~1) | | | |
| 8 groups-7 | rank (0~1) | | | |
| 8 groups-8 | rank (0~1) | | | |

One of the benefits of this scheme lies in low overhead.

For a 4Tx or 2Tx precoding matrix, the candidate codebooks can be: the number of codebooks for coherent or full coherent codebooks can be determined based on a set of precoding matrix parameters, such as N1, N2, O1, O2, i_{1,1}, i_{1,2}, i_{1,3}, and/ or i2, which could determine a flexible size of candidate codebook set; or the number of codebooks for coherent or full coherent codebooks can be determined based on predetermined precoding matrices, such as the partial/ non coherent codebooks predefined for uplink precoding with 4Tx or 2Tx.

### VI. Embodiment 3: DCI Field. Indication Type B: Separate Fields for Groups

A UE receives a type indication, or coherent capability information. The type indication can be coherent capability information.

A UE or NW determines one or more indication fields in a DCI, a MAC CE or an RRC signaling according to at least one of the type indication, or the coherent capability information.

Or a UE/NW determines G groups, each group corresponding to an indication field in a DCI, a MAC CE or an RRC signaling.

The indication field indicates one ranks, and with or without one TPMI.

The type indication may indicate one from the first type, the second type, the third type, and the fourth type, or from the first type, the second type, and the third type, or from the first type, and the second type.

The coherent capability information may comprise one of the following for 8 port:
Cap 1: full+partial1+partial2+non coh
Cap2: partial1+partial2+non coh
Cap3: partial2+non coh
Cap4: non coh

Cap1 corresponds to the first type. Cap2 corresponds to the second type. Cap3 corresponds to the third type. Cap4 corresponds to the fourth type.

For the first type of entries, there is only one group. one indication field indicates one rank and one TPMI for one group;

For the second type of entries, there are two groups. two indication fields each of which indicates one rank and one TPMI for one group;

For the third type of entries, there are four groups. Four indication fields each of which indicates one rank and one TPMI for one group;

For the fourth type of entries, there are 8 groups. 8 indication fields each of which indicates one rank for one group, or one indication field indicates eight ranks. A UE or NW determines bit size of an indication field corresponding to a type

according to the number of entries corresponding to the type. E.g., ┌log 2(N)┐. N is the number of entries corresponding to the type.

A UE or NW determines a number of a type of entries according to the number of candidate codebook set for the type of matrix, as described above.

A UE or NW determines a sum bit size of all indication fields in a DCI, a MAC CE or an RRC signaling according to a maximum value of a list of sum bit size of all indication fields for each type, or according to a predefined or a pre-configured value.

For example,

For the first type of entries, bit size for one indication field is 9 bit.

For the second type of entries, bit size for each indication field is 7 bit. The sum bit size of all indication fields for second type is 14 bits.

For the third type of entries, bit size for each indication field is 3 bit. The sum bit size of all indication fields for third type is 12 bits.

For the fourth type of entries, bit size for each indication field is 1 bit. The sum bit size of all indication fields for third type is 8 bits.

A UE or NW determines a sum bit size of all indication fields in a DCI, according to a maximum value of a list of sum bit size of all indication fields for each type, as 14, which is maximum value of the list of 9, 14, 12, 8.

TABLE B
Separate fields for groups

| switch | 1 field | | | | | | | |
|---|---|---|---|---|---|---|---|---|
| | rank 1~8 + TPMI | | | | | | | |
| or | 2 fields | | | | | | | |
| | rank 0~4 + TPMI | | rank 0~4 + TPMI | | | | | |
| or | 4 fields | | | | | | | |
| | rank 0~2 + TPMI | | rank 0~2 + TPMI | | rank 0~2 + TPMI | | rank 0~2 + TPMI | |
| or | 8 fields, or one combination 8-bit field | | | | | | | |
| | rank_1 | rank_2 | rank_3 | rank_4 | rank_5 | rank_6 | rank_7 | rank_8 |
| | or 8 rank | | | | | | | |
| | combination | | | | | | | |

### VII. Embodiment 4: DCI Field. Indication Type C: Rank Indication+1 or More TPMI

A UE receives a rank indication information in a DCI, a MAC CE or an RRC signaling from a NW.

The UE receives zero or one or more TPMI fields and/or the bit size of the TPMI field according to the rank indication information.

Further, the UE determines one or more ranks for one or more groups based on the rank indication information.

The UE determines one separate TPMI field for each of the one or more ranks. Or the UE determines one common TPMI field for the one or more ranks. Or the UE determines there is no TPMI field for the one or more ranks, if the number of ranks larger than 4, e.g., 8.

The rank indication information

Bit size of TPMI corresponding to a type is determined according to the number of codebooks in a candidate precoding set corresponding to the type. E.g., ┌log 2(N)┐. N is the number of codebooks in a candidate precoding set corresponding to the type.

The number of codebooks in a candidate precoding set corresponding to the type is determined according to a predefined candidate codebook set, such as table x-1 to 5.

A UE or NW determines a sum bit size of all TPMI fields in a DCI, a MAC CE or an RRC signaling according to a maximum value of a list of sum of maximum bit size of for a rank all TPMI fields for each type, or according to a predefined or a pre-configured value.

For example,

For the first type of entries, maximum bit size for one TPMI field is 7 bit (128 precoders) for rank=2, as shown in column 2 in table x-1, or 9 bit (512 precoders) for rank=2 as shown in column 3 in table x-2.

For the second type of entries, maximum bit size for each TPMI field is 5 bit (32 precoders) as shown in table x-2. The sum bit size of all TPMI fields for second type is 10 bits.

For the third type of entries, maximum bit size for each TPMI field is 2 bit. The sum bit size of all TPMI fields for third type is 8 bits as shown in table x-4.

For the fourth type of entries, no TPMI field is needed, bit size is 0.

A UE or NW determines a sum bit size of all indication fields in a DCI, according to a maximum value of a list of sum bit size of all TPMI fields for each type, as 10, which is maximum value of the list of 9, 10, 8, 0.

TABLE C
Rank indication + 1 or more TPMI

| | | 1 or more fields for | |
|---|---|---|---|
| 1 field | | TPMI(s): | |
| rank indication: | 1 rank (1~8) | switch | 1 TPMI |
| | 2 rank (0~4) | or | 1 or more TPMI |
| | 4 rank (0~2) | or | 1 or more TPMI |
| | 8 rank (0~1) | or | no TPMI |

The more than one TPMI can also be jointly indicated in a TPMI field.

### VIII. Embodiment 5: Precoding Matrix, for All Cases A/B/C

A UE determines one or more ranks, and/or the one or more TPMIs, as in embodiment 2, 3, or 4.

A precoding matrix (or a precoder) is determined by the one or more ranks, and/or the one or more TPMIs.

For the first type, one rank, e.g., R, with a value of 1-8, is determined, and the precoding matrix with size of 8*R is determined according to one TPMI.

For the second type, two ranks, e.g., R1, R2, with a value of 0-4, are determined, and a matrix with size of 4*R1 and a matrix with size of 4*R2 are determined according to one or two TPMIs. And the precoding matrix is determined as one of:

A precoding matrix with size of 8*(R1+R2): the elements in the matrix with size of 4*R1 are placed in row #1, #2, #5, #6 (or #1, #2, #3, #4) and columns #1˜R1, and the elements in the matrix with size of 4*R2 are placed in row #3, #4 #7, #8 (or #5, #6, #7, #8) and columns #R1+1, ˜#R1+R2, and other elements in the precoding matrix are zeroes.

A precoding matrix with size of 8*max(R1, R2): the elements in the matrix with size of 4*R1 are placed in row #1, #2, #5, #6 (or #1, #2, #3, #4) and columns #1˜R1, and the elements in the matrix with size of 4*R2 are placed in row #3, #4 #7, #8 (or #5, #6, #7, #8) and columns #1˜#R2, and other elements in the precoding matrix are zeroes. This case is applied if UE capability related information comprises a layer alignment among port groups. Each rank corresponds to a port group, which comprises 4 ports.

For the third type, four ranks, e.g., R1, R2, R3, R4 with a value of 0-2, are determined, and four matrices with size of 4*R1, 4*R2, 4*R3, 4*R4, are determined according to one or two or four TPMIs. And the precoding matrix is determined as one of:

A precoding matrix with size of 8*(R1+R2+R3+R4): the elements in the matrix with size of 2*R1 are placed in row #1, #5 (or #1, #2) and columns #1˜R1, and the elements in the matrix with size of 2*R2 are placed in row #2, #6 (or #3, #4) and columns #R1+1, ˜#R1+R2, the elements in the matrix with size of 2*R3 are placed in row #3, #7 (or #5, #6) and columns #R1+R2+1, ˜#R1+R2+R3, and the elements in the matrix with size of 2*R4 are placed in row #4, #8 (or #7, #8) and columns #R1+R2+R3+1, ˜#R1+R2+R3+R4, and other elements in the precoding matrix are zeroes.

A precoding matrix with size of 8*max(R1, R2, R2, R3): the elements in the matrix with size of 2*R1 are placed in row #1, #5 (or #1, #2) and columns #1˜R1, and the elements in the matrix with size of 2*R2 are placed in row #2, #6 (or #3, #4) and columns #1, ˜#R2, the elements in the matrix with size of 2*R3 are placed in row #3, #7 (or #5, #6) and columns #1, ˜#R3, and the elements in the matrix with size of 2*R4 are placed in row #4, #8 (or #7, #8) and columns #1, ˜#R4, and other elements in the precoding matrix are zeroes. This case is applied if UE capability related information comprises a layer alignment among port groups. Each rank corresponds to a port group, which comprises 2 ports.

### IX. Embodiment 6: UE Capability Related

UE capability related information reported by UE to NW, or configured by NW to UE, or determined by UE comprises at least one of:
Coherent capability, comprising:
   a. Cap1: 8 port full+partial1+partial2+non-coherent
   b. Cap2: 8 port partial1+partial2+non-coherent
   c. Cap3: 8 port partial2+non-coherent
   d. Cap4: 8 port non-coherent
   e. Full coherent refers to all ports are coherent. Partial 1 coherent or first partial type coherent refers to there are two 4-port groups; partial 2 coherent or second partial type coherent refers to there are four 2-port groups; the ports within one port group are coherent. The ports among different port groups are not coherent or coherent.
Shared or common TPMI/vector indication among all port groups
Shared or common TPMI/vector indication among part of port groups
   a. For cap1, common TPMI/vector can be enabled by default among 2 groups for second type, or among 4 groups for third type.
   b. For cap2, common TPMI/vector can be enabled according to UE capability or NW configuration among 2 groups for second type.
   c. For cap2, common TPMI/vector can be enabled by default or according to UE capability or NW configuration among 4 groups for third type, or among 2 groups within a group corresponding to second type. E.g., there are four port groups for third type, port group 4-1, 4-2, 4-3 and 4-4. and there are 2 port groups for second type, port group 2-1, and 2-2. port group 4-1 and 4-3 are within port group 2-1, and port group 4-2 and 4-4 are within port group 2-2. then port group 4-1 and 4-3 can share a common TPMI/vector by default or according to UE capability for UE with coherent capability of cap2.
   d. For cap3, common TPMI/vector can be enabled according to UE capability or NW configuration among 4 groups for third type.
Separate TPMI/vector indications among port groups
Layer alignment indication among all port groups (phase offset between port groups may be needed)
Layer alignment indication among part of port groups (phase offset between port groups may be needed)
Non layer alignment indication among part of port groups
Maximum number of layers for a port group
Maximum number of layers for more than one port group
An offset of numbers of layers among port groups is not greater than a predefined value, e.g., 1. if rank for one port group is 0, this rule may not be applied.
The rank for the port group with lower index is equal to or larger than the rank for the port group with higher index.

If the capability comprise a common precoding matrix indicator among port groups each of which corresponds to a rank, an entry of type two indicates two ranks and one precoding matrix indicator, and the one precoding matrix indicator is shared by the two port groups corresponding to the two ranks with values of R1 and R2. The precoding matrix for rank 1 and rank 2 is first R1 or R2 columns of the precoding matrix based on the one precoding matrix indicator.

Similarly, if the capability comprise a common precoding matrix indicator among port groups each of which corresponds to a rank, an entry of type three indicates four ranks and one precoding matrix indicator, and the one precoding matrix indicator is shared by the four port groups corresponding to the four ranks.

If a capability comprises a layer alignment among port groups, when determining a precoder, multiple precoding matrices corresponding to multiple ranks are all arranged from layer one, or column one. For example, sizes of precoding matrix for port group 1 and group 2 are both 4*2 which means port group 1 and port group 2 both comprise 4 ports, and both precoding matrices are for 2 layers (rank =2). A precoder for 8 Tx ports are determined as size of 8*2, where 8 ports correspond to two 4-port groups, and 2 layers are aligned.

### X. Embodiment 7: Determine Number of Precoding Matrices for a Certain Rank

For UL transmission, number of candidate precoding matrices for a rank can be same as or different from that for another rank. Number of candidate precoding matrices for a rank can be determined according to at least one of the following precoding matrix parameters:

Number of antenna layout, such as N1, or N2,

Oversampling factor, e.g., O1, or O2

Phase offset (phi), e.g., candidate value set for i₂

Offset of layer, e.g., candidate value set for i_{1,3}

Note that candidate value set of i_{1,1}, or i_{1,2}, depends on value of Number of antenna layout and/or Oversampling factor.

A value (or a candidate value set) of a precoding matrix parameter can be determined in a predetermined manner, such as a fixed value (or fixed value set), or can be determined according to a parameter configured or indicated by gNB.

A default value can be determined for a precoding matrix parameter for one or more ranks. The default values for different ranks may be same or different. The default value can be determined in a predetermined manner, or can be determined according to a mode parameter, or other kind of matrix parameter.

A particular value can be determined for a precoding matrix parameter for one or more particular ranks, e.g., according to a mode parameter. For the particular rank, the particular value is used instead of the default value.

The mode parameter can be used to determine the value or the candidate value set of a precoding matrix parameter for one or more ranks. UE determines candidate precoding matrices for a rank which has a value smaller than a maximum rank for the UE.

For example, a default value can be determined for a precoding matrix parameter, such as number of antenna layout for all ranks, as N1=4, N2=1, O1=1, and/or O2=1. A particular value, such as or O1=4 is determined for rank=2 according to a mode parameter. Then the value of O1 should be 4 for rank=2, and 1 for other ranks.

For example, a default value can be determined for a precoding matrix parameter, such as number of antenna layout for all ranks, as N1=4, N2=1, O1=1, and/or O2=1. A particular value, such as or O1=0 is determined for rank=1 according to a mode parameter. Then the value of O1 should be 0 for rank=1, and 1 for other ranks. That means no candidate precoding matrix for rank 1.

For example, a default value set for Phase offset (phi), e.g., candidate value set for i2 can be determined as {0, 1, 2, 3} for rank 1, and {0, 1} for other ranks. A particular value set, such as {0, 1} is determined for rank=1 according to a mode parameter. Then the value set for Phase offset (phi), e.g., candidate value set for i2 can be for all ranks.

For example, a default value set for Offset of layer, e.g.,candidate value set for i1,3 can be determined as {0, 1, 2, 3} for rank 2, and {0, 1, 2} for rank 3 and rank 4. A particular value set, such as {0, 1} can be determined for rank=2, 3, 4 according to a first mode parameter. Or a particular value set, such as {0} can be determined for rank=2, 3, 4 according to a second mode parameter.

For example, M precoding matrices are determined for a rank as default, N precoding matrices are determined for the rank according to a mode parameter. Where M or N is an integer. N can be smaller or larger than M. If N is smaller than M, the N precoding matrices are a subset of the M precoding matrices; If N is larger than M, the N precoding matrices are a extensive set of the M precoding matrices.

The extensive set may include the M precoding matrices and other precoding matrices are determined based on the M precoding matrices, e.g., with same basic vector, with larger oversampling factor, with larger candidate set for a precoding matrix parameter.

The subset of M precoding matrices can be determined by one of a half or a quarter of M precoding matrices, such as the first, last, or a certain part. The N precoding matrices can be determined by a first N indexed precoding matrices in the M precoding matrices, or a first N even/odd indexed precoding matrices in the M precoding matrices.

The mode parameter can be carried in a MAC CE, or in a RRC signaling, or in a DCI signaling. If the mode parameter is carried in a DCI signaling, the mode parameter is applicable after the DCI signaling, e.g., after an ACK related to the DCI signaling, or a period after an ACK related to the signaling. The ACK related to the DCI signaling comprises a PUCCH or PUSCH with a HARQ-ACK for the DCI signaling, or with a HARQ-ACK for the PUCCH or PUSCH scheduled by the DCI signaling.

In reality, the above mode parameter can be in one parameter or more than one parameters.

With above scheme, number of candidate precoding matrices can enlarged or reduced for one or more particular ranks. The above parameter, including the mode parameter, or other kind of matrix parameter, can be received by UE from gNB (or NW, network). The gNB may determine such parameter according to statistics of quality of PUSCH from the UE. For cell edge UEs, e.g., with low ranks, can be configured with parameters which leads to a larger set of precoding matrices for the low ranks, and small set of precoding matrices for high ranks. For some UEs which has few chances to use a certain rank, the number of precoding matrices for such rank can be 0 or very small value, e.g., 1.

The value of rank can be an integer which is 1, 2, . . . , 8, and smaller than a maximum rank for a UE.

The particular rank can be a predefined value, such as one or more certain ranks, e.g., one of rank 1, 2, . . . or 8, or ranks with values smaller than an integer, e.g., 4, or a predefined set of ranks, e.g., rank 2, and 3.

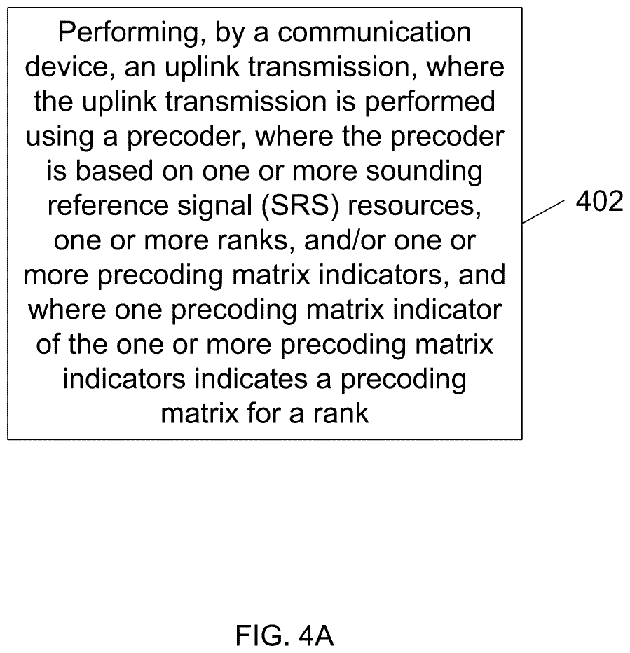

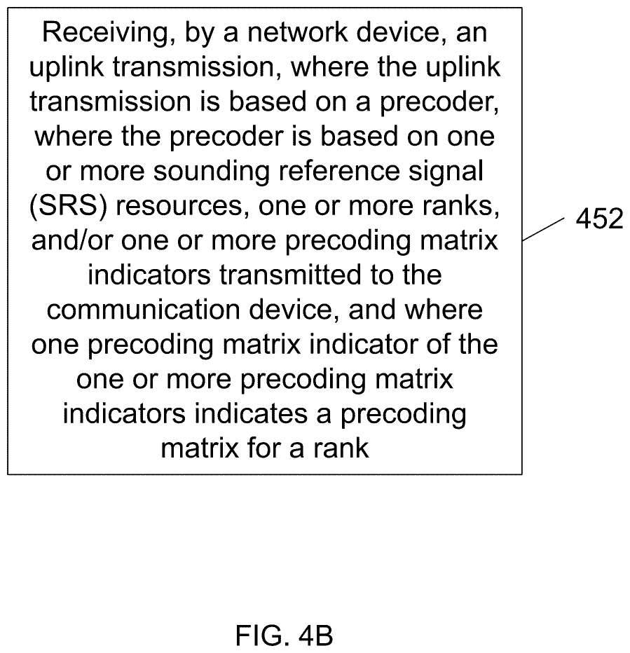

FIG. 4A shows an exemplary flowchart for performing an uplink transmission. Operation 402 includes performing, by a communication device, an uplink transmission, where the uplink transmission is performed using a precoder, where the precoder is based on one or more sounding reference signal (SRS) resources, one or more ranks, and/or one or more precoding matrix indicators, and where one precoding matrix indicator of the one or more precoding matrix indicators indicates a precoding matrix for a rank.

In some embodiments, the one precoding matrix indicator of the one or more precoding matrix indicators comprises: a transmitted precoding matrix indicator (TPMI) or an index that indicates the precoding matrix for the rank based on a predefined precoding matrix table, or a set of parameters to determine the precoding matrix for the rank. In some embodiments, at least two SRS resources from the one or more SRS resources are configured with a sum of eight antenna ports, or one SRS resource of the one or more SRS resources is configured with eight antenna ports. In some embodiments, at least one SRS resource is indicated by one SRS resource indicator (SRI), each of the at least one SRS resource is indicated by a respective SRI in one SRS resource set, or each of the at least one SRS resource is indicated by a respective SRI corresponding to a respective SRS resource set. In some embodiments, the method further comprises receiving, by the communication device from a network device, a first indication having a value that indicates the one or more ranks and/or the one or more precoding matrix indicators.

In some embodiments, the value of the first indication indicates the one or more ranks and/or the one or more precoding matrix indicators based on a predetermined table, the predetermined table comprises a plurality of entries, each entry of the plurality of entries corresponds to a respective value of the first indication, and each entry of the plurality of entries corresponds to at least one rank and/or at least one precoding matrix indicator. In some embodiments, the plurality of entries comprise any one or more of: one or more entries of type one, one or more entries of type two, one or more entries of type three, or one or more entries of type four, where each of the type one, the type two, the type three, and the type four is associated with at least one rank and/or at least one precoding matrix indicator. In some embodiments, more than one entry with different types correspond to any one or more of: different number of ranks, different value range of ranks, different number of precoding matrix indicators, or different size of precoding matrices corresponding to precoding matrix indicators. In some embodiments, an entry of type one indicates one rank and/or one precoding matrix indicator, an entry of type two indicates two ranks and/or one precoding matrix indicator or two precoding matrix indicators, an entry of type three indicates four ranks and/or one precoding matrix indicator or four precoding matrix indicators, or an entry of type four indicates eight ranks.

In some embodiments, a bit size of the first indication is according to any one or more of: a predefined value, a parameter configured by the network device, or a number of entries in the predetermined table. In some embodiments, the method further comprises receiving, by the communication device from a network device, a type indication, and one or more second indications, one of the one or more second indications indicates one rank, and a number of the one or more second indications or a bit size of a second indication is according to or based on a relationship with the type indication. In some embodiments, the one of the one or more second indications indicates one rank and one precoding matrix indicator. In some embodiments, the one of the one or more second indications indicates one rank without a precoding matrix indicator. In some embodiments, the type indication indicates one of: a type one which indicates one group, a type two which indicates two groups, a type three which indicates four groups, or a type four which indicates eight groups or a special group.

In some embodiments, each group corresponds to a respective second indication, or the special group corresponds to a second indication which indicates a combination of ranks. In some embodiments, the method further comprises receiving, by the communication device from a network device, a rank indication, and zero or one or more third indications, where the rank indication indicates one or more ranks, and where one of the one or more third indications indicates one precoding matrix indicator corresponding to a rank indicated by the rank indication. In some embodiments, a number of the one or more third indications or a bit size of a third indication is according to or based on a relationship with the rank indication. In some embodiments, the method further comprises transmitting, from the communication device to the network device, any one or more of the following capabilities: a coherent capability, a common or separate precoding matrix indicator among port groups, a layer alignment among port groups, or a maximum number of layers for a port group; or receiving, by the communication device from the network device, any one or more of the following capabilities: a coherent capability, a common or separate precoding matrix indicator among port groups, a layer alignment among port groups, or a maximum number of layers for a port group.

In some embodiments, the coherent capability comprises any one or more of: capability 1 with full coherent, first partial type coherent, second partial type coherent, and non-coherent capabilities, capability 2 with first partial type coherent, second partial type coherent, and non-coherent capabilities, capability 3 with second partial type coherent, and non-coherent capabilities, or capability 4 with non-coherent capability. In some embodiments, the method further comprises receiving, by the communication device from a network device, a mode parameter, where the communication device determines a value or a candidate value set of a precoding matrix parameter for one or more ranks according to the mode parameter. In some embodiments, a value of the mode parameter is associated with the value or the candidate value set of the precoding matrix parameter for the one or more ranks. In some embodiments, the communication device determines a value of an oversampling factor for one or more ranks according to the mode parameter, the communication device determines a value set of a precoding matrix parameter of phase offset according to the mode parameter, or the communication device determines a value set of a precoding matrix parameter of layer offset according to the mode parameter.

In some embodiments, the mode parameter is received in a downlink control information (DCI) signaling, a medium access control-control element (MAC CE) signaling, or a radio resource control (RRC) signaling. In some embodiments, a default value of a precoding matrix parameter is determined in a predetermined manner, or is determined according to a parameter configured or indicated by the network device for a rank, and a particular value determined for the precoding matrix parameter for one or more particular ranks according to the mode parameter updates the default value for the one or more particular ranks. In some embodiments, a particular value determined for a precoding matrix parameter for one or more particular ranks is according to the mode parameter, and a default value of the precoding matrix parameter is determined in a predetermined manner, or is determined according to a parameter configured or indicated by the network device for a rank other than the one or more particular ranks. In some embodiments, the communication device determines a value or a candidate value set of a precoding matrix parameter for one or more ranks to be different from that for another rank. In some embodiments, the precoding matrix parameter comprises any one or more of an oversampling factor, a number of horizontal antenna elements on one polarization, or a number of vertical antenna elements on one polarization.

FIG. 4B shows an exemplary flowchart for receiving an uplink transmission. Operation 452 includes receiving, by a network device, an uplink transmission, where the uplink transmission is based on a precoder, where the precoder is based on one or more sounding reference signal (SRS) resources, one or more ranks, and/or one or more precoding matrix indicators transmitted to the communication device, and where one precoding matrix indicator of the one or more precoding matrix indicators indicates a precoding matrix for a rank.

In some embodiments, the one precoding matrix indicator of the one or more precoding matrix indicators comprises: a transmitted precoding matrix indicator (TPMI) or an index that indicates the precoding matrix for the rank based on a predefined precoding matrix table, or a set of parameters to determine the precoding matrix for the rank. In some embodiments, at least two SRS resources from the one or more SRS resources are configured with a sum of eight antenna ports, or one SRS resource of the one or more SRS resources is configured with eight antenna ports. In some embodiments, at least one SRS resource is indicated by one SRS resource indicator (SRI), each of the at least one SRS resource is indicated by a respective SRI in one SRS resource set, or each of the at least one SRS resource is indicated by a respective SRI corresponding to a respective SRS resource set. In some embodiments, the method further comprises transmitting, by the network device to the communication device, a first indication having a value that indicates the one or more ranks and/or the one or more precoding matrix indicators.

In some embodiments, the value of the first indication indicates the one or more ranks and/or the one or more precoding matrix indicators based on a predetermined table, and the predetermined table comprises a plurality of entries, each entry of the plurality of entries corresponds to a respective value of the first indication, and each entry of the plurality of entries corresponds to at least one rank and/or at least one precoding matrix indicator. In some embodiments, the plurality of entries comprise any one or more of: one or more entries of type one, one or more entries of type two, one or more entries of type three, or one or more entries of type four, where each of the type one, the type two, the type three, and the type four is associated with at least one rank and/or at least one precoding matrix indicator. In some embodiments, more than one entry with different types correspond to any one or more of: different number of ranks, different value range of ranks, different number of precoding matrix indicators, or different size of precoding matrices corresponding to precoding matrix indicators. In some embodiments, an entry of type one indicates one rank and/or one precoding matrix indicator, an entry of type two indicates two ranks and/or one precoding matrix indicator or two precoding matrix indicators, an entry of type three indicates four ranks and/or one precoding matrix indicator or four precoding matrix indicators, or an entry of type four indicates eight ranks. In some embodiments, a bit size of the first indication is determined according to any one or more of: a predefined value, a parameter configured by the network device, or a number of entries in the predetermined table.

In some embodiments, the method further comprises transmitting, by the network device to the communication device, a type indication, and one or more second indications, where one of the one or more second indications indicates one rank, and where a number of the one or more second indications or a bit size of a second indication is determined according to or based on a relationship with the type indication. In some embodiments, the one of the one or more second indications indicates one rank and one precoding matrix indicator. In some embodiments, the one of the one or more second indications indicates one rank without a precoding matrix indicator. In some embodiments, the type indication indicates one of: a type one which indicates one group, a type two which indicates two groups, a type three which indicates four groups, or a type four which indicates eight groups or a special group. In some embodiments, each group corresponds to a respective second indication, or the special group corresponds to a second indication which indicates a combination of ranks.

In some embodiments, the method further comprises transmitting, by the network device to the communication device, a rank indication, and one or more third indications, where the rank indication indicates one or more ranks, and where one of the one or more third indications indicates one precoding matrix indicator corresponding to a rank indicated by the rank indication. In some embodiments, a number of the one or more third indications or a bit size of a third indication is determined according to or based on a relationship with the rank indication. In some embodiments, the method further comprises receiving, by the network device from the communication device, any one or more of the following capabilities: a coherent capability, a common or separate precoding matrix indicator among port group, a layer alignment among port groups, or a maximum number of layers for a port group; or transmitting, by the network device to the communication device, any one or more of the following capabilities: a coherent capability, a common or separate precoding matrix indicator among port group, a layer alignment among port groups, or a maximum number of layers for a port group.

In some embodiments, the coherent capability comprises any one or more of: capability 1 with full coherent, first partial type coherent, second partial type coherent, and non-coherent capabilities, capability 2 with first partial type coherent, second partial type coherent, and non-coherent capabilities, capability 3 with second partial type coherent, and non-coherent capabilities, or capability 4 with non-coherent capability. In some embodiments, the method further comprises transmitting, by the network device to the communication device, a mode parameter, where a value or a candidate value set of a precoding matrix parameter for one or more ranks is based on the mode parameter. In some embodiments, a value of the mode parameter is associated with the value or the candidate value set of the precoding matrix parameter for the one or more ranks. In some embodiments, the mode parameter is transmitted in a downlink control information (DCI) signaling, a medium access control-control element (MAC CE) signaling, or a radio resource control (RRC) signaling.

In some embodiments, a default value of a precoding matrix parameter is determined in a predetermined manner, or is determined according to a parameter configured or indicated by the network device for a rank, and a particular value determined for the precoding matrix parameter for one or more particular ranks according to the mode parameter updates the default value for the one or more particular ranks. In some embodiments, a particular value determined for a precoding matrix parameter for one or more particular ranks is according to the mode parameter, and a default value of the precoding matrix parameter is determined in a predetermined manner, or is determined according to a parameter configured or indicated by the network device for a rank other than the one or more particular ranks.

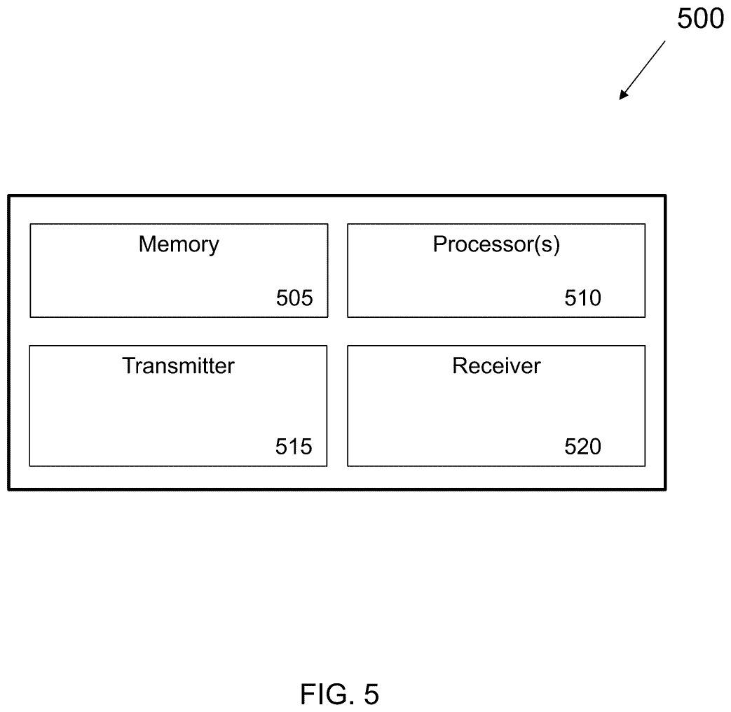

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4B and 6, and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

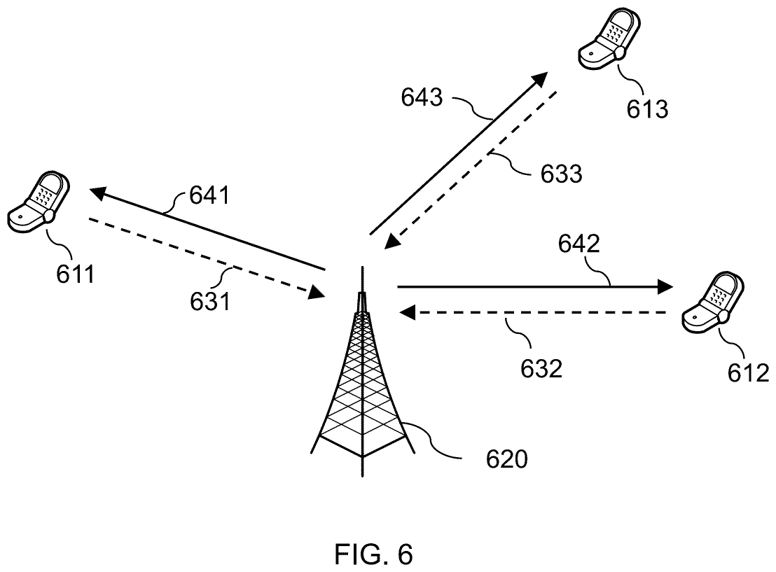

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
performing, by a communication device, an uplink transmission,
wherein the uplink transmission is performed using a precoder,
wherein the precoder is based on one sounding reference signal (SRS) resource, one or more ranks, and one or more precoding matrix indicators, and
wherein one precoding matrix indicator of the one or more precoding matrix indicators indicates a precoding matrix for a rank.

2. The method of claim 1, wherein the one precoding matrix indicator of the one or more precoding matrix indicators comprises:
a transmitted precoding matrix indicator (TPMI) or an index that indicates the precoding matrix for the rank based on a predefined precoding matrix table.

3. The method of claim 1, wherein the one SRS resource is configured with eight antenna ports.

4. The method of claim 1, wherein the one SRS resource is indicated by one SRS resource indicator (SRI).

5. The method of claim 1, further comprise:
receiving, by the communication device from a network device, a first indication having a value that indicates the one or more ranks and the one or more precoding matrix indicators.

6. The method of claim 5,
wherein the value of the first indication indicates the one or more ranks and/or the one or more precoding matrix indicators based on a predetermined table,
wherein the predetermined table comprises a plurality of entries,
wherein each entry of the plurality of entries corresponds to a respective value of the first indication, and
wherein each entry of the plurality of entries corresponds to at least one rank and at least one precoding matrix indicator.

7. The method of claim 6, wherein the plurality of entries comprise any one or more of:
one or more entries of type one,
one or more entries of type two,
one or more entries of type three, or
one or more entries of type four,
wherein each of the type one, the type two, the type three, and the type four is associated with at least one rank and/or at least one precoding matrix indicator.

8. The method of claim 7, wherein more than one entry with different types correspond to any one or more of:
different number of precoding matrix indicators, or
different size of precoding matrices corresponding to precoding matrix indicators.

9. The method of claim 7,
wherein an entry of type one indicates one rank and one precoding matrix indicator,
wherein an entry of type two indicates two ranks and two precoding matrix indicators, or
wherein an entry of type three indicates four ranks and four precoding matrix indicators.

10. The method of claim 5, wherein a bit size of the first indication is according to any one or more of:
a parameter configured by the network device, or
a number of entries in the predetermined table.

11. A wireless communication method, comprising:
receiving, by a network device, an uplink transmission,
wherein the uplink transmission is based on a precoder,
wherein the precoder is based on one sounding reference signal (SRS) resource, one or more ranks, and one or more precoding matrix indicators transmitted to the communication device, and
wherein one precoding matrix indicator of the one or more precoding matrix indicators indicates a precoding matrix for a rank.

12. The method of claim 11, further comprise:
transmitting, by the network device to the communication device, a first indication having a value that indicates the one or more ranks and the one or more precoding matrix indicators.

13. An apparatus for wireless communication comprising a processor configured to implement a method, the processor configured to:
perform, by a communication device, an uplink transmission,
wherein the uplink transmission is performed using a precoder,
wherein the precoder is based on one sounding reference signal (SRS) resource, one or more ranks, and one or more precoding matrix indicators, and
wherein one precoding matrix indicator of the one or more precoding matrix indicators indicates a precoding matrix for a rank.

14. The apparatus of claim 13, wherein the one precoding matrix indicator of the one or more precoding matrix indicators comprises:
a transmitted precoding matrix indicator (TPMI) or an index that indicates the precoding matrix for the rank based on a predefined precoding matrix table.

15. The apparatus of claim 13, wherein the one SRS resource is configured with eight antenna ports.

16. The apparatus of claim 13, wherein the one SRS resource is indicated by one SRS resource indicator (SRI).

17. The apparatus of claim 13, wherein the processor is further configured to:
receive, by the communication device from a network device, a first indication having a value that indicates the one or more ranks and the one or more precoding matrix indicators.

18. The apparatus of claim 17,
wherein the value of the first indication indicates the one or more ranks and/or the one or more precoding matrix indicators based on a predetermined table,
wherein the predetermined table comprises a plurality of entries,
wherein each entry of the plurality of entries corresponds to a respective value of the first indication, and
wherein each entry of the plurality of entries corresponds to at least one rank and at least one precoding matrix indicator.

19. An apparatus for wireless communication comprising a processor configured to implement a method, the processor configured to:
receive, by a network device, an uplink transmission,
wherein the uplink transmission is based on a precoder,
wherein the precoder is based on one sounding reference signal (SRS) resource, one or more ranks, and one or more precoding matrix indicators transmitted to a communication device, and
wherein one precoding matrix indicator of the one or more precoding matrix indicators indicates a precoding matrix for a rank.

20. The apparatus of claim 19, wherein the processor is further configured to:
transmit, by the network device to the communication device, a first indication having a value that indicates the one or more ranks and the one or more precoding matrix indicators.
